(19) United States
(12) Patent Application Publication
(10) Pub. No.: US 2026/0149287 A1
(43) Pub. Date: May 28, 2026

(54) CURRENT SHARING CONTROL CIRCUIT, POWER PROVIDER, AND POWER SUPPLY SYSTEM THEREOF

(71) Applicant: HON HAI PRECISION INDUSTRY CO., LTD., New Taipei (TW)

(72) Inventor: ZHEN-XU CHAN, New Taipei (TW)

(21) Appl. No.: 19/328,373

(22) Filed: Sep. 15, 2025

(30) Foreign Application Priority Data
Nov. 28, 2024 (CN) 202411728461.0

(51) Int. Cl. H02J 3/46; H02J 3/00

(52) U.S. Cl. CPC H02J 3/46; H02J 3/001

(57) ABSTRACT

A current sharing control circuit includes a controller and a current feedback circuit. The controller is configured to output a current control signal to a power supply circuit for indicating an output terminal of the power supply circuit. The current feedback circuit is configured to output a corresponding feedback signal to a current sharing bus based on the current control signal. The current feedback signal is a current signal. The controller is also configured to receive a voltage of the current sharing bus and adjust the current control signal based on the voltage of the current sharing bus. Thus, the current sharing control circuit achieves a stable and precision current sharing control of the output currents of power providers in a power supply system, which are electrically connected in parallel. A power provider and a power supply system are also provided.

### TECHNICAL FIELD

The present application generally relates to power technology, and particularly to a current sharing control circuit, a power provider, and a power supply system thereof.

### BACKGROUND

As the development of power technology, a power supply system with several powers connected in parallel are widely used. The power supply system includes several power providers, output terminals of the power providers are electrically connected in parallel. For improving an output efficiency of the power supply, a current sharing control is provided for controlling an output current of each of the power providers. How to achieve the current sharing control becomes an urgent issue to be addressed.

There is room for improvement in the art.

### BRIEF DESCRIPTION OF THE DRAWINGS

Implementations of the present application will now be described, by way of example only, with reference to the attached figures.

FIG. 1 is a diagram illustrating an embodiment of a power supply system according to the present application, the power supply system includes several power providers.

FIG. 2 is a diagram illustrating an embodiment of a power provider of FIG. 1 according to the present application, the power provider includes a current sharing control circuit.

FIG. 3 is a diagram illustrating an embodiment of a current sharing control circuit of FIG. 2 according to the present application.

FIG. 4 is a circuit diagram illustrating an embodiment of a current sharing control circuit of FIG. 2 according to the present application.

### DETAILED DESCRIPTION

It may be understood that the connection relationship described in this application is a direct or indirect connection. For example, that A is connected to B may not only be that A is directly connected to B, but also be that A is indirectly connected to B by using one or more other electrical components. For example, it may be that A is directly connected to C, and C is directly connected to B. In this way, A is connected to B by using C. it may be further understood that “A is connected to B” described in this application may be that A is directly connected to B, or may be that A is indirectly connected to B by using one or more other electrical components.

In descriptions of this application, unless otherwise specified, “/” means “or”. For example, A/B may represent A or B. The term “and/or” in this application describes only an association relationship between associated objects and indicates that there may be three relationships. For example, A and/or B may represent the following three cases: Only A exists, both A and B exist, and only B exists.

In the descriptions of the application, the words such as “first” and “second” are used to distinguish between different objects, and do not limit quantities and execution sequences. In addition, the words such as “first” and “second” do not necessarily limit a definite difference. In addition, terms “include” and “have”, and any variant thereof are intended to cover the non-exclusive inclusion.

As the development of power technology, a power supply system with several powers connected in parallel are widely used. The power supply system includes several power providers, output terminals of the power providers are electrically connected in parallel. For improving an output efficiency of the power supply, a current sharing control is provided for controlling an output current of each of the power providers. How to achieve the current sharing control becomes an urgent issue to be addressed.

Thus, the present application provides a current sharing control circuit, a power provider, and a power supply system, which may provide accurate and steady current sharing control for controlling a current in the power supply system with several power providers.

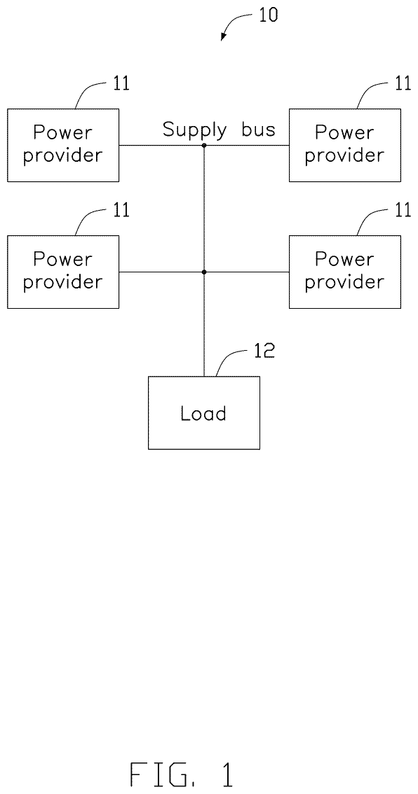

Referring to FIG. 1, FIG. 1 shows the power supply system 10 according to the present application. The power supply system 10 includes several power providers 11. An output terminal of each of the power providers 11 is electrically connected with a supply bus, and the supply bus is electrically connected with at least one load 12. Thus, the output terminals of the power providers 11 are electrically connected in parallel, and the power providers 11 power the at least one load 12 through the supply bus.

In some embodiments, the power provider 11 is a power supply unit (PSU).

Therefore, by electrically connecting the power providers 11 in parallel, an output power of the power supply system 10 is improved, which is suitable for the at least one load 12 with a relative large power needs. Besides, a redundancy of the power supply system 10 is also improved, therefore the power supply system 10 avoids from being stopped running due to the failure of one of the power provider, a reliability of the power supply system 10 is also improved.

Based on this, due to the difference in an output voltage and an output resistance of each of the power provider 11, output currents of the power providers 11 may be different. There is a current path existed between the power providers 11, which causes the output power of each of the power provider 11 to be different. For example, an output power of one or more power providers 11 worked in a heavy load state is higher than an output power of one or more rest power providers 11 worked in an idle or light load state. The output power of one or more rest power providers 11 worked in an idle or light load state may be close to zero. Thus, the reliability of the power supply system 10 is reduced, and a service life of the power supply system 10 is shortened.

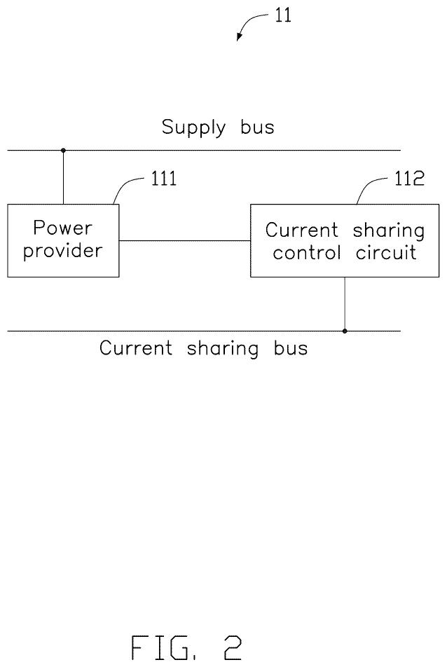

In detail, referring to FIG. 2, FIG. 2 shows a diagram of the power provider 11 according to the present application. The power provider 11 includes a power supply circuit 111 and a current sharing control circuit 112.

The power supply circuit 111 is electrically connected with the supply bus. The power supply circuit 111 is configured to provide an output current to the supply bus for powering the load 12.

The current sharing control circuit 112 is electrically connected with the power supply circuit 111. The current sharing control circuit 112 is configured to output a current control signal to the power supply circuit 111. The current control signal is configured to indicate the output current of the power supply circuit 111. In that means, the current sharing control circuit 112 may adjust the current control signal for adjusting the output current of the power supply circuit 111. The adjustment parameters of the current control signal may include a voltage, a current, a waveform, a duty cycle, and a frequency of the current control signal, and so on, but not being limited.

The current sharing control circuit 112 is further electrically connected with a current sharing bus. The current sharing control circuit 112 is also configured to output a current feedback signal to the current sharing bus based on the current control signal. The current sharing control circuit 112 is also configured to adjust the current control signal based on a voltage on the current sharing bus. In some embodiments, the structure and the connection relationship of each of the power providers 11 in the power supply system 10 is common, details are not described herein again. Therefore, all of the current sharing control circuit 112 corresponding to the power providers 11 in the power supply system 10 provide the current feedback signal to the current sharing bus. While the current feedback signal is a voltage signal, the larger distance between different power providers 11 is, the longer the length of the current sharing bus is. While transmitting on the current sharing bus with a longer length, the voltage signal is susceptible to electromagnetic interference, which cause the voltage on the current sharing bus to be unstable. Due to the voltage on the current sharing bus as basic for adjusting the current control signal of the current sharing control circuit 112, a stability of the voltage on the current sharing bus will directly affect an accuracy of the current control signal, thereby a precision of the output current of the power supply circuit 111 is affected.

For solving the above problems, the output current feedback signal of the current sharing control circuit 112 may be made to be a current signal. While transmitting on the current sharing bus, the current signal will be less susceptible by the electromagnetic interference, thus the stability of the voltage on the current sharing bus will be improved, and a precision in the control of the output current of the power supply circuit 111 is improved.

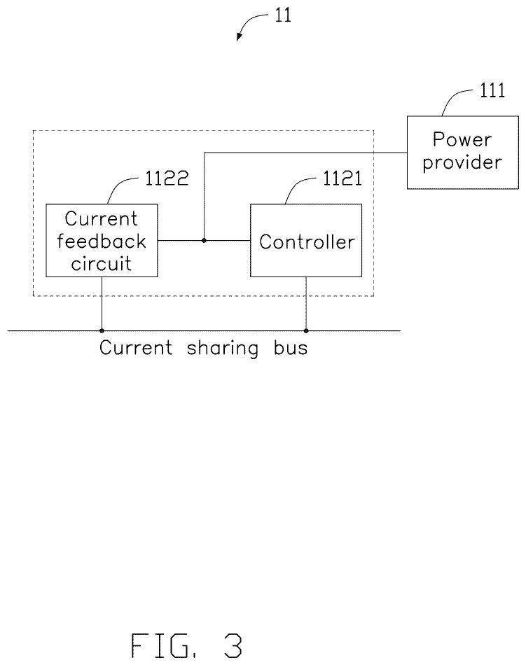

In detail, referring to FIG. 3, FIG. 3 shows a diagram of the current sharing control circuit 112 according to the present application. The current sharing control circuit 112 includes a controller 1121 and a current feedback circuit 1122.

The controller 1121 is electrically connected with the power supply circuit 111 and the current feedback circuit 1122. The controller 1121 is configured to output the current control signal to the power supply circuit 111 and the current feedback circuit 1122, for controlling the output current of the power supply circuit 111.

The current feedback circuit 1122 is electrically connected with the current sharing bus. The current feedback circuit 1122 is configured to output the current feedback signal based on the current control signal. The current feedback signal is a current signal, and is configured to indicate the output current of the power supply circuit 111 corresponding to the current control signal.

The controller 1121 is also configured to receive the voltage on the current sharing bus by an output terminal of the current feedback circuit 1122 and adjust the current control signal based on the voltage on the current sharing bus.

Due to the current sharing bus being electrically connected with several current sharing control circuits 112, the current feedback signal of each current sharing control circuit 112 is provided to the current sharing bus, and the voltage on the current sharing bus is depended on the current feedback signal of each current sharing control circuit 112. The voltage on the current sharing bus may present an average of the current feedback signals of all of the current sharing control circuits 112. In that means, the voltage on the current sharing bus may be presented by an average value of the output currents of all of the current sharing control circuits 112. Based on this, each controller 1121 adjusts the current control signal based ono the voltage on the current sharing bus, and the output current of each power supply circuit 111 is adjusted based on the average value of the output currents of the power supply circuits 111. Therefore, the output current of the power supply circuit 111 is common, for achieving a current sharing control in the output current of all of the power providers 11.

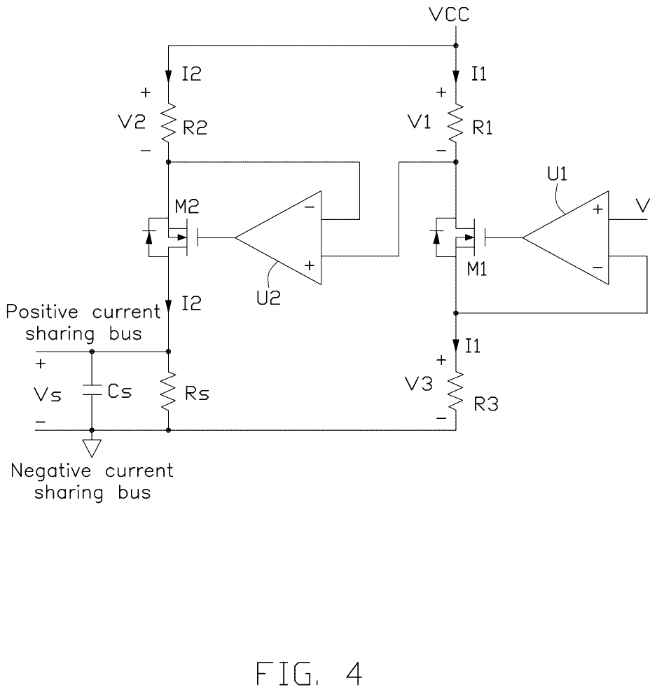

Referring to FIG. 4, FIG. 4 shows a detail circuit diagram of the current control circuit 112 according to the present application. The current sharing bus includes a positive current sharing bus and a negative current sharing bus. The current feedback circuit 1122 includes a positive current sharing feedback circuit and a negative current sharing feedback circuit. Accordingly, the current feedback signal includes a first current feedback signal and a second current feedback signal. The negative current feedback circuit is configured to output the first current feedback signal to the negative current sharing bus based on the current control signal. The positive current feedback circuit is configured to output the second current feedback signal to the positive current sharing bus based on the voltage of a first terminal of the negative current sharing bus.

In detail, the negative current sharing bus feedback circuit includes a first operational amplifier U1, a first transistor M1, a first pull-up resistor R1, and a pull-down resistor R3. The positive current sharing bus feedback circuit includes a second operational amplifier U2, a second pull-up resistor R2, and a second transistor resistor M2. Besides, the current feedback circuit 1122 further includes a current sharing resistor Rs and a current capacitor Cs.

A first terminal of the first pull-up resistor R1 is electrically connected with a first terminal of the second pull-up resistor R2. The first terminals of the first pull-up resistor R1 and the second pull-up resistor R2 receive an input voltage VCC. A second terminal of the first pull-up resistor R1 is electrically connected with an inverting terminal of the second operational amplifier U2 and a first terminal of the second transistor M2, and a second terminal of the second pull-up resistor R2 is electrically connected with a non-inverting terminal of the second operational amplifier U2. An output terminal of the second operational amplifier U2 is electrically connected with a second terminal of the second transistor M2. A third terminal of the second transistor M2 is electrically connected with a first terminal of the current sharing resistor Rs, a first terminal of the current sharing capacitor Cs, and the positive current sharing bus. The third terminal of the second transistor M2 outputs the second current feedback signal 12.

The second terminal of the first pull-up resistor R1 is electrically connected with a first terminal of the first transistor M1, a second terminal of the first transistor M1 is electrically connected with an output terminal of the first operational amplifier U1, a non-inverting terminal of the first operational amplifier U1 is electrically connected with the controller 1121. The non-inverting terminal of the first operational amplifier U1 is configured to receive the current control signal outputted by the controller 1121. The current control signal may be a voltage signal. The inverting terminal of the first operational amplifier U1 is electrically connected with a third terminal of the first transistor M1 and a first terminal of the pull-down resistor R3. A second terminal of the pull-down resistor R3 is electrically connected with a second terminal of the current sharing resistor Rs, a second terminal of the current sharing capacitor Cs, and the negative current sharing bus. The second terminal of the pull-down resistor R3 outputs the first feedback signal I1.

In some embodiments, the first transistor M1 is a N-channel metal oxide semiconductor field effect transistor (MOSFET), and the second transistor M2 is a P-channel MOSFET. The first terminal of the first transistor M1 is a drain terminal, the second terminal of the first transistor M1 is a gate terminal, and the third terminal of the first transistor M1 is a source terminal. The first terminal of the second transistor M2 is a drain terminal, the second terminal of the second transistor M2 is a gate terminal, and the third terminal of the second transistor M2 is a source terminal.

Based on a virtual break principle, a virtual short principle, a resistor voltage dividing principle of the first operational amplifier U1 and the second operational amplifier U2, the voltage of the current control signal and the voltages between the first terminal and the second terminal of the current sharing resistor Rs satisfy with the following formular (1).

$$\frac{V s}{V} = \frac{R 1 \cdot Rs}{R 3 \cdot R 2 \cdot ( s \cdot Cs \cdot Rs + 1 )} \qquad Formular ( 1 )$$

Wherein, Vs represents a voltage between the positive current sharing bus and the negative current sharing bus, which is equal to the voltage between the first terminal and the second terminal of the current sharing resistor Rs, and is equal to the voltage between the first terminal and the second terminal of the current sharing capacitor Cs. V represents the voltage of the current control signal. The voltage of the current control signal is configured to indicate the output current of the power supply circuit 111. R1 represents the first pull-up resistor. Rs represents the first current sharing resistor. R3 represents the pull-down resistor. R2 represents the second pull-up resistor.

Therefore, the negative current sharing bus feedback circuit and the positive current sharing bus feedback circuit of the current sharing control circuit 112 output the first feedback signal I1 and the second feedback signal 12 respectively to the current sharing bus. Due to being related with the voltage of the current sharing bus, the first feedback signal and the second feedback signal are current signals, the stability of the current sharing bus is improved, and the precision in the control of the output current of the power supply circuit 111 is also improved.

Therefore, the current sharing control circuit 112, the power provider 11, and the power supply system 10 according to the present application may achieve the stable and precision current sharing control of the output currents of the power providers 11 in the power supply system 10, which are electrically connected in parallel.

Those skilled in the art will recognize that the above described embodiments are only intended to illustrate the invention and are not intended to limit the invention, and numerous possible modifications and variations within the spirit of the invention will fall within the scope of the invention.

What is claimed is:

1. A current sharing control circuit, applicable in a power supply system with at least one power providers, which are electrically connected in parallel; each of the at least one power providers comprises a power supply circuit and the current sharing control circuit; the current sharing control circuit comprising:
a controller, configured to electrically connect with the power supply circuit in a corresponding power provider of the at least one power providers, and output a current control signal to the power supply circuit, the current control signal indicating an output terminal of the power supply circuit; and
a current feedback circuit, electrically connected with the controller, and configured to output a feedback signal to a current sharing bus of the corresponding power provider based on the current control signal;
wherein an output terminal of the current feedback circuit connected to the corresponding power provider is further electrically connected with the current sharing bus of the corresponding power provider; the current feedback circuit is further configured to output the current feedback signal as a current signal; the controller is further configured to receive a voltage of the current sharing bus of the corresponding power provider and adjust the current control signal based on the voltage of the current sharing bus.

2. The current sharing control circuit of claim 1, wherein the current feedback circuit comprises a positive current sharing bus feedback circuit and a negative current sharing bus feedback circuit; the current feedback circuits is further configured to output the current feedback signal comprising a first current feedback signal and a second current feedback signal; an input terminal of the negative current sharing bus feedback circuit is electrically connected with the controller; an output terminal of the negative current sharing bus feedback circuit is electrically connected with a negative current sharing bus of the current sharing bus; the negative current sharing bus feedback circuit is configured to output the first feedback signal to the negative current sharing bus of the current sharing bus based on the current control signal; an input terminal of the positive current sharing feedback circuit is electrically connected with the first terminal of the negative current sharing bus feedback circuit; an output terminal of the positive current sharing bus feedback circuit is electrically connected with a positive current sharing bus of the current sharing bus; the positive current sharing bus feedback circuit is configured to output the second feedback signal to the positive current sharing bus of the current sharing bus.

3. The current sharing control circuit of claim 2, wherein the negative current sharing bus feedback circuit comprises a first operational amplifier, a first transistor, a first pull-up resistor, and a pull-down resistor; a first terminal of the first pull-up resistor receives an input voltage; a second terminal of the first pull-up resistor is electrically connected with a first terminal of the first transistor and serves as a first terminal of the negative current sharing bus feedback circuit; a second terminal of the first transistor is electrically connected with an output terminal of the first operational amplifier; a non-inverting input terminal of the first operational amplifier serves as an input terminal of the negative current sharing bus feedback circuit; an inverting terminal of the first operational amplifier is electrically connected with a third terminal of the first transistor; the third terminal of the first transistor is further electrically connected with a first terminal of the pull-down resistor; a second terminal of the pull-down resistor serves as an output terminal of the negative current sharing bus feedback circuit.

4. The current sharing control circuit of claim 2, wherein the positive current sharing bus feedback circuit comprises a second operational amplifier, a second transistor, and a second pull-up resistor; a first terminal of the second pull-up resistor receives an input voltage; a second terminal of the second pull-up resistor is electrically connected with a first terminal of the second transistor and a non-inverting input terminal of the second operational amplifier; a second terminal of the second transistor is electrically connected with an output terminal of the second operational amplifier; an inverting terminal serves as an input terminal of the positive current sharing bus feedback circuit; a third terminal of the second transistor is further electrically connected with an output terminal of the positive current sharing bus feedback circuit.

5. The current sharing control circuit of claim 2, wherein the current sharing control circuit further comprises a current sharing resistor; two opposite terminals of the current sharing resistor are electrically connected with the positive current sharing bus and the negative current sharing bus respectively; a voltage of the current sharing bus comprises a voltage between the opposite terminals of the current sharing resistor.

6. The current sharing control circuit of claim 2, wherein the current sharing control circuit further comprises a current sharing capacitor; two opposite terminals of the current sharing capacitor are electrically connected with the positive current sharing bus and the negative current sharing bus respectively; a voltage of the current sharing bus comprises a voltage between the opposite terminals of the current sharing capacitor.

7. The current sharing control circuit of claim 3, wherein the first transistor is a N-channel metal oxide semiconductor field effect transistor (MOSFET), the first terminal of the first transistor is a drain terminal, the second terminal of the first transistor is a gate terminal, and the third terminal of the first transistor is a source terminal.

8. The current sharing control circuit of claim 4, wherein the second transistor is a P-channel metal oxide semiconductor field effect transistor (MOSFET), the first terminal of the first transistor is a drain terminal, the second terminal of the first transistor is a gate terminal, and the third terminal of the first transistor is a source terminal.

9. A power provider configured to be used in a power supply system; the power provider comprises a power supply circuit and a current sharing control circuit; the current sharing control circuit comprising: comprises:
a controller, electrically connected with the power supply circuit in a corresponding power provider of the at least one power providers, and configured to output a current control signal to the power supply circuit, the current control signal indicating an output terminal of the power supply circuit; and
a current feedback circuit, electrically connected with the controller of the corresponding power provider, and configured to output a corresponding feedback signal to a current sharing bus of the corresponding power provider based on the current control signal;
wherein an output terminal of the current feedback circuit connected to the corresponding power provider is further electrically connected with the current sharing bus; the current feedback circuit is further configured to output the current feedback signal as a current signal; the controller is further configured to receive a voltage of the current sharing bus and adjust the current control signal based on the voltage of the current sharing bus.

10. The power provider of claim 9, wherein the current feedback circuit comprises a positive current sharing bus feedback circuit and a negative current sharing bus feedback circuit; the current feedback signal comprises a first current feedback signal and a second current feedback signal; an input terminal of the negative current sharing bus feedback circuit is electrically connected with the controller; an output terminal of the negative current sharing bus feedback circuit is electrically connected with a negative current sharing bus of the current sharing bus; the negative current sharing bus feedback circuit is configured to output the first feedback signal to the negative current sharing bus of the current sharing bus based on the current control signal; an input terminal of the positive current sharing feedback circuit is electrically connected with the first terminal of the negative current sharing bus feedback circuit; an output terminal of the positive current sharing bus feedback circuit is electrically connected with a positive current sharing bus of the current sharing bus; the positive current sharing bus feedback circuit is configured to output the second feedback signal to the positive current sharing bus of the current sharing bus.

11. The power provider of claim 10, wherein the negative current sharing bus feedback circuit comprises a first operational amplifier, a first transistor, a first pull-up resistor, and a pull-down resistor; a first terminal of the first pull-up resistor receives an input voltage; a second terminal of the first pull-up resistor is electrically connected with a first terminal of the first transistor and serves as a first terminal of the negative current sharing bus feedback circuit; a second terminal of the first transistor is electrically connected with an output terminal of the first operational amplifier; a non-inverting input terminal of the first operational amplifier serves as an input terminal of the negative current sharing bus feedback circuit; an inverting terminal of the first operational amplifier is electrically connected with a third terminal of the first transistor; the third terminal of the first transistor is further electrically connected with a first terminal of the pull-down resistor; a second terminal of the pull-down resistor serves as an output terminal of the negative current sharing bus feedback circuit.

12. The power provider of claim 10, wherein the positive current sharing bus feedback circuit comprises a second operational amplifier, a second transistor, and a second pull-up resistor; a first terminal of the second pull-up resistor receives an input voltage; a second terminal of the second pull-up resistor is electrically connected with a first terminal of the second transistor and a non-inverting input terminal of the second operational amplifier; a second terminal of the second transistor is electrically connected with an output terminal of the second operational amplifier; an inverting terminal serves as an input terminal of the positive current sharing bus feedback circuit; a third terminal of the second transistor is further electrically connected with an output terminal of the positive current sharing bus feedback circuit.

13. The power provider of claim 10, wherein the current sharing control circuit further comprises a current sharing resistor; two opposite terminals of the current sharing resistor are electrically connected with the positive current sharing bus and the negative current sharing bus respectively; a voltage of the current sharing bus comprises a voltage between the opposite terminals of the current sharing resistor.

14. The power provider of claim 10, wherein the current sharing control circuit further comprises a current sharing capacitor; two opposite terminals of the current sharing capacitor are electrically connected with the positive current sharing bus and the negative current sharing bus respectively; a voltage of the current sharing bus comprises a voltage between the opposite terminals of the current sharing capacitor.

15. A power supply system comprises:
a plurality of power providers, electrically connected in parallel and further electrically connected to a common current sharing bus, each of the plurality of power providers comprises a power supply circuit and a current sharing control circuit; the current sharing control circuit comprising:
a controller, electrically connected with the power supply circuit in a corresponding power provider of the at least one power providers, and configured to output a current control signal to the power supply circuit, the current control signal indicating an output terminal of the power supply circuit; and
a current feedback circuit, electrically connected with the controller of the corresponding power provider, and configured to output a feedback signal to a current sharing bus of the corresponding power provider based on the current control signal;
wherein an output terminal of the current feedback circuit connected to the corresponding power provider is further electrically connected with the current sharing bus; the current feedback circuit is further configured to output the current feedback signal as a current signal; the controller is further configured to receive a voltage of the current sharing bus and adjust the current control signal based on the voltage of the current sharing bus.

16. The power supply system of claim 15, wherein the current feedback circuit comprises a positive current sharing bus feedback circuit and a negative current sharing bus feedback circuit; the current feedback signal comprises a first current feedback signal and a second current feedback signal; an input terminal of the negative current sharing bus feedback circuit is electrically connected with the controller; an output terminal of the negative current sharing bus feedback circuit is electrically connected with a negative current sharing bus of the current sharing bus; the negative current sharing bus feedback circuit is configured to output the first feedback signal to the negative current sharing bus of the current sharing bus based on the current control signal; an input terminal of the positive current sharing feedback circuit is electrically connected with the first terminal of the negative current sharing bus feedback circuit; an output terminal of the positive current sharing bus feedback circuit is electrically connected with a positive current sharing bus of the current sharing bus; the positive current sharing bus feedback circuit is configured to output the second feedback signal to the positive current sharing bus of the current sharing bus.

17. The power supply system of claim 16, wherein the negative current sharing bus feedback circuit comprises a first operational amplifier, a first transistor, a first pull-up resistor, and a pull-down resistor; a first terminal of the first pull-up resistor receives an input voltage; a second terminal of the first pull-up resistor is electrically connected with a first terminal of the first transistor and serves as a first terminal of the negative current sharing bus feedback circuit; a second terminal of the first transistor is electrically connected with an output terminal of the first operational amplifier; a non-inverting input terminal of the first operational amplifier serves as an input terminal of the negative current sharing bus feedback circuit; an inverting terminal of the first operational amplifier is electrically connected with a third terminal of the first transistor; the third terminal of the first transistor is further electrically connected with a first terminal of the pull-down resistor; a second terminal of the pull-down resistor serves as an output terminal of the negative current sharing bus feedback circuit.

18. The power supply system of claim 16, wherein the positive current sharing bus feedback circuit comprises a second operational amplifier, a second transistor, and a second pull-up resistor; a first terminal of the second pull-up resistor receives an input voltage; a second terminal of the second pull-up resistor is electrically connected with a first terminal of the second transistor and a non-inverting input terminal of the second operational amplifier; a second terminal of the second transistor is electrically connected with an output terminal of the second operational amplifier; an inverting terminal serves as an input terminal of the positive current sharing bus feedback circuit; a third terminal of the second transistor is further electrically connected with an output terminal of the positive current sharing bus feedback circuit.

19. The power supply system of claim 16, wherein the current sharing control circuit further comprises a current sharing resistor; two opposite terminals of the current sharing resistor are electrically connected with the positive current sharing bus and the negative current sharing bus respectively; a voltage of the current sharing bus comprises a voltage between the opposite terminals of the current sharing resistor.

20. The power supply system of claim 16, wherein the current sharing control circuit further comprises a current sharing capacitor; two opposite terminals of the current sharing capacitor are electrically connected with the positive current sharing bus and the negative current sharing bus respectively; a voltage of the current sharing bus comprises a voltage between the opposite terminals of the current sharing capacitor.
